(19) United States
(12) Patent Application Publication
(10) Pub. No.: US 2003/0126242 A1
(43) Pub. Date: Jul. 3, 2003

(54) Network boot system and method using remotely-stored, client-specific boot images created from shared, base snapshot image

(76) Inventor: Albert H. Chang, Houston, TX (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/035,377

(22) Filed: Dec. 28, 2001

(51) Int. Cl. G06F 15/177; G06F 1/24

(52) U.S. Cl. 709/222; 713/2

(57) ABSTRACT

A method and system for network booting of clients linked to a network. The method includes receiving a boot request from a networked client device and determining a target. The target is determined for the client device and a boot volume is selected from a set of client image copies. Each client image copy is unique to a client device and is created using a snapshot of a base boot image with a virtual copy or reverse snapshot of the base image being stored for each client device. The method continues with logging the client into the target and providing direct access to the allocated client image copy. The client device remotely boots from the client boot volume(s) or blocks on a remote storage device. Each client image copy includes the base boot image and information specific to the client. The client information is updated with writes to automatically allocated client-specific blocks.

### BACKGROUND OF THE INVENTION

1. Field of the Invention

The present invention relates, in general, to data storage networking technology, and more particularly, to a reverse snapshot system and method for performing a network boot remotely over a communication network or fabric using a unique, private image of the operating system, applications, and other system information (e.g., a system base image) for each client.

2. Relevant Background

Organizations are continuing to experience rapid and often painful growth in their data storage needs. Researchers anticipate that while the cost per megabyte of storage will continue to decrease, the cost of storage will actually increase due to costs associated with accessing, maintaining, managing and securing data and data storage systems. The data storage industry has responded to the storage needs by providing pooled storage devices that are directly attached to a communication network such as an internet protocol (IP) or Fibre Channel (FC) network infrastructure or fabric. For example, storage area networks (SANs) represent one storage networking solution in which client devices are able to directly address shared storage in blocks of data. While addressing some of the cost and demand issued faced by organizations, existing storage networking solutions have resulted in additional storage management problems.

In a typical network environment, multiple client computer systems, such as servers, desktop computers, and the like, are connected to one or more server computer systems. In many storage network environments, it is beneficial for each of the clients, such as web servers, to be configured, at least initially, to be functionally identical. Such initial configuration of the clients generally involves installing an operating system (OS) and applications image, i.e., a boot image, to local, bootable disk storage or memory at the client. On power-up or reboot, the client boots from the operating system stored in local, bootable disk storage without communication with the network server.

A number of techniques have been used for providing this boot image but each has its drawbacks. The boot image can be installed in the local disk storage from removable storage media, such as a floppy or compact disk, or be pre-installed at the factory. Manual installation increases the system cost and also is not useful for addressing the need for maintaining coherent system images across functionally equivalent computer nodes. Coherency is lost when OS and application patches, upgrades, and the like are inconsistently installed in the clients changing the blocks of the boot image that were common to the networked clients.

Network boot methods have made some progress in addressing the need for coherency among clients and rapid deployment of OS and application images. In existing network boot methods, the client transmits a boot request to a boot server (e.g., a server operating under network communication protocols such as tftp, bootstrap protocol (BootP), and the like) which responds by assigning the client's IP address or otherwise providing the IP address which is returned to the client. The client then transmits a request following a communication protocol expected by the boot server (e.g., a request using a communication protocol such as trivial file transfer protocol (tftp)). The boot server then retrieves from remote storage and transmits the OS and application image or boot image to the client. Generally, the same image is transmitted to each requesting client in the network. Existing network boot methods typically require the client to have local disk or RAM disk storage for storing the OS and application image. The client then boots off the local image. Such network boot methods are undesirable because they require a relatively large amount of time for deployment and installation of OS and application images to local storage. Additionally, client storage capacity is being consumed or wasted by the downloading of the boot images to the local storage.

Recovery techniques have been developed in redundant disk storage architectures, such as RAID storage systems, and other systems to recover from operating system failure caused by corruption of OS files or corruption of the root file or OS system itself. One technique calls for taking a snapshot or making a copy image of the OS system and application files at a particular time, and typically again periodically, which are stored to another location (e.g., in an identical disk storage unit or in a large-capacity storage medium). When OS or application problems arise, the contents of the OS and application volumes revert to the snapshot or copy image. Cloning is a similar process in which a clone is formed of the OS and application image and typically shares the same disk space in the data storage system (e.g., provide two identical collections of hard links to the same files). Again, the clone acts as a backup of an image only at the time it was taken or formed. The existing snapshot and cloning techniques require local memory at the client to be effective and fail to address the need for coherent management of identical function clients in a network.

Hence, there remains a need for an improved method and system for deploying similarly functioning client computer systems in a network or for network booting OS and application images in such client computer systems. Preferably, such a method and system would require less physical intervention at each computer node or client, require no or little local storage which in turn would reduce power, space, and cooling requirements for the client. Further, such a method and system would preferably consolidate boot image storage and improve external storage controller caching and disk seek performance.

### SUMMARY OF THE INVENTION

The present invention addresses the above discussed and additional problems by providing a network boot system that facilitates client booting from a client-specific image on a remote storage device. The remote network system is useful for maintaining coherent system images across functionally equivalent computer nodes or client devices to address patching and upgrade issues. The network boot system is especially adapted to improve the time required to install and deploy operating systems (OS) and applications to clients and for managing distributed storage while also increasing data storage efficiency. The network boot system provides a quick replication time of a boot volume based on snapshot and copy-on-write processes, reduces overall disk utilization, and improves read performance of unmodified blocks that are common across functionally equivalent nodes because of spatial and temporal locality. Specifically, spatial locality of unmodified blocks is provided in the original volume because these blocks are shared by the functionally equivalent clients. Temporal locality of caching unmodified blocks is provided in the original volume because the clients are grouped in some embodiments to perform similar functions. Additionally, the network boot system is able to dynamically assign or create boot volumes to clients across a communication network when the boot process starts, which assists in re-deployment of clients for different functions.

More particularly, a method and corresponding system is provided for controlling network booting of a plurality of client devices linked to a data communications network (e.g., an IP-based storage network such as iSCSI or other communication network configurations such as a Fibre Channel (FC) or InfiniBand (IB) storage network). The method includes receiving a boot request from one of the networked client devices and in response, determining a target boot volume (or set of data blocks). The target boot volume is determined based on a client identifier for the client device and is selected from a set of client image boot volumes or copies. The client image copies are particular or unique to a specific one of the client devices and are created using a base boot image with a reverse snapshot of the base image being stored for each device. The base image itself may be created by a number of methods including copying, creating, or snapshotting. The method continues with logging the client, or in the iSCSI embodiment, a iSCSI initiator, in to the target software and hardware associated with the target boot volume and providing direct access to the allocated or assigned client image copy. The client device is then able to remotely boot from the client boot volume on a remote storage device rather than on local bootable storage.

The base boot image is stored in a shared storage pool and is used to facilitate adding additional client devices by creating new client image reverse snapshots as needed. The base boot image includes a standard or shared operating system and application file image to facilitate rapid deployment of numerous client devices providing similar or identical functions throughout a network. Each client image copy includes physically common operating system (OS) and application blocks for storing the base boot image and client-specific blocks for storing information specific to the particular client device. The client-specific blocks are preferably allocated and/or updated when writes or similar commands or messages are received (e.g., writes do not touch common OS and application image blocks but instead are client-specific).

### BRIEF DESCRIPTION OF THE DRAWINGS

FIG. 1 is an illustration of a network boot system according to the present invention illustrating an external storage controller managing access to client-specific boot images for remote booting;

FIG. 2 is a simplified block diagram illustrating sequential communications or messaging among the components of the network booting system of FIG. 1; and

FIG. 3 is a flow chart illustrating processes carried out by the external storage controller during operation of the network boot system of FIG. 1.

### DETAILED DESCRIPTION OF THE PREFERRED EMBODIMENTS

The present invention is directed toward a network boot system and method that reduces or even eliminates the need for local storage at boot clients (e.g., servers, desktop computers, laptop or wireless devices, and the like). The network boot system and method are particularly suited to a network in which all of the client devices (or groups of client devices as the invention is not limited to one boot image) perform similar or identical functions because client devices are remotely booted from boot images having a common operating system (OS) and application block. The following description stresses how the invention extends existing snapshot and backup techniques to allow booting from the communication fabric or network rather than requiring downloading of a boot image to local, bootable memory. The network boot system and method are well-suited for storage communication networks configured with communication, connection, and transport protocol, such as iSCSI (small computer system interface (SCSI) information encapsulated by TCP/IP to allow its transfer over IP-based-network fabric), iFCP, and FCIP protocols that move block data over IP networks; SRP for IB (InfiniBand); FCP for FC (Fibre Channel); and other block data protocols and networking infrastructures, which present remote, and often pooled, storage to the client as if it were local storage at the client.

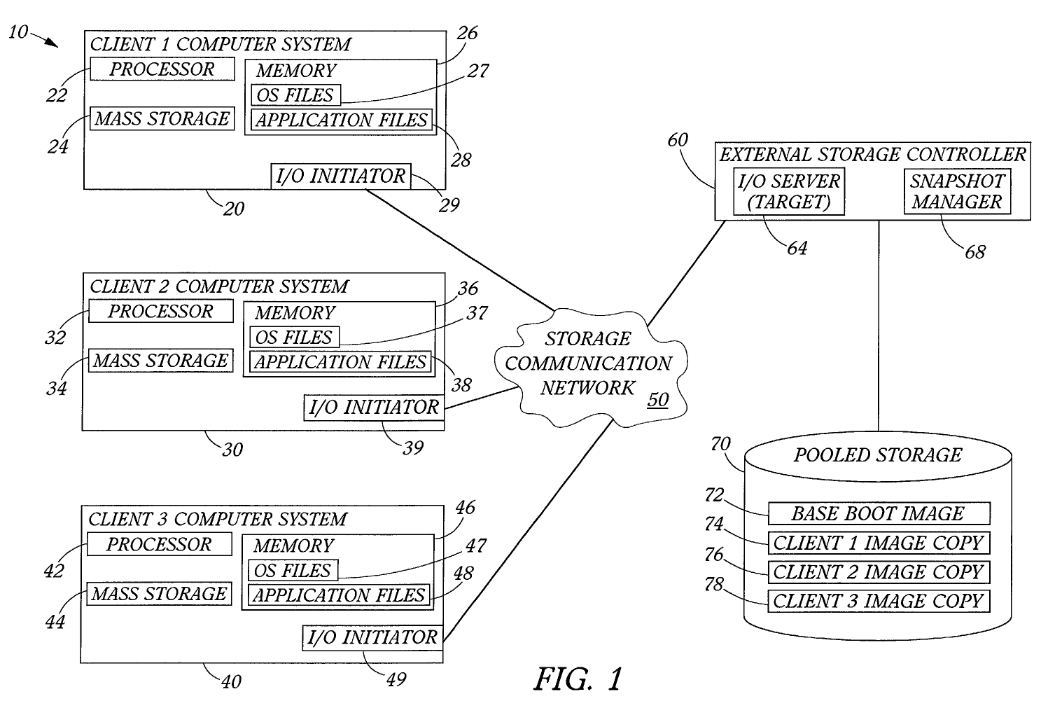

Referring to FIG. 1, a network boot system 10 is provided that is operable according to the invention to facilitate remote booting of a plurality of clients via a network fabric. As illustrated, the network boot system 10 includes three client computer systems (i.e., clients) 20, 30, and 40 linked to a storage communication network 50. An external storage controller or server 60 is also linked to the communication network 50 and adapted for performing the reverse snapshot method of the invention as discussed below including booting and controlling access to the pooled storage 70 which contains system 10 boot images.

In one embodiment, the clients 20, 30, and 40 are configured with similar hardware and software to provide similar or identical functions. The clients 20, 30, and 40 may be any of a number of network devices such as web servers, file servers, personal desktop, laptop, or handheld, or other wired or wireless computing devices communicatively linked to the storage communication network 50. As shown, the clients 20, 30, and 40 include processors or CPUs 22, 32, 42 and optionally mass storage 24, 34, and 44 (e.g., single or multiple magnetic disk drives, such as, but not limited to, a RAID (redundant array of independent disks) arrangement). Memory 26, 36, 46 (e.g., RAM) is provided for storing the running OS 27, 37, 47 and applications 28, 38, 48. Of course, the clients 20, 30, and 40 may also include keyboards or other input devices and displays or monitors. In one preferred embodiment, the clients 20, 30, 40 perform equivalent functions and are deployed using the same OS files 27, 37, 47, and application configurations 28, 38, 48.

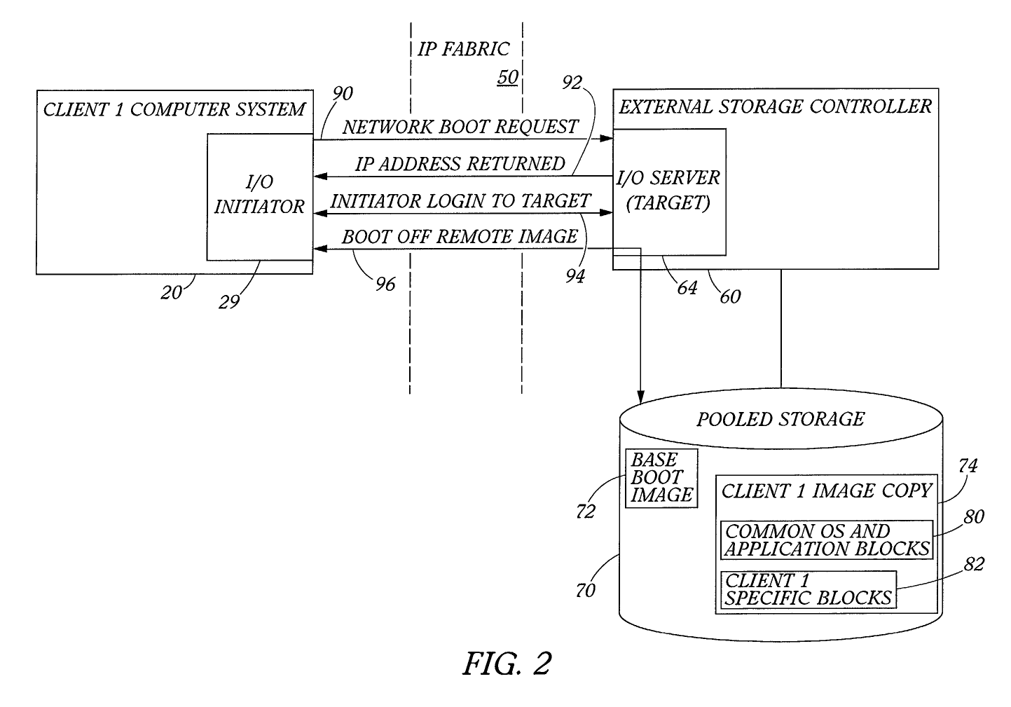

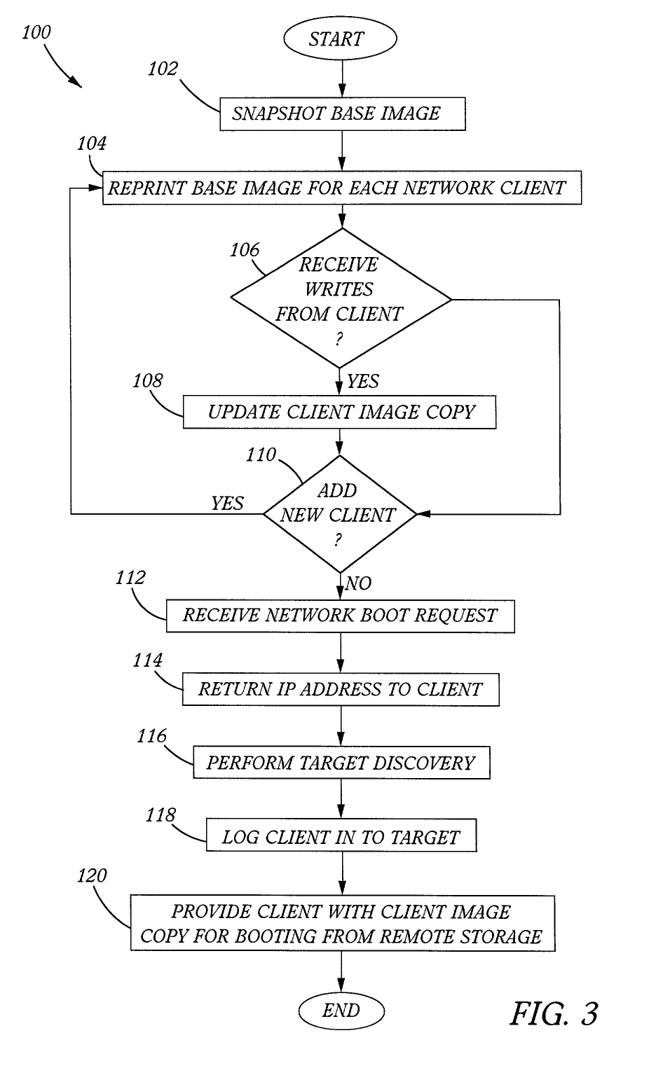

Each of the clients 20, 30, 40 further includes an input/output (I/O) initiator 29, 39, 49 that functions at least to issue or broadcast boot requests to the external storage controller 60. Preferably, the I/O initiator 29, 39, 49 further functions to communicate over the network 50 with the external storage controller 60 to receive the client's IP address, to login to the storage communication network target, and to boot off the remote client image copy in the pooled storage 70 (as will be explained with reference to FIGS. 2 and 3). The network 50 may be a number of data communication networks, including those based on IP-protocol such as iSCSI, iFCP, and FCIP, or other block data protocols including FC and IB protocols.

In one embodiment, iSCSI (often referred to as storage area network (SAN) over IP) is used for its features that facilitate storage area networking over the network 50. With iSCSI, SCSI information is encapsulated by TCP/IP to allow its transport over IP-based network (such as Ethernet and Gigabit Ethernet). This allows the storage attached to the network 50 (such as pooled storage 70) to be accessed by the same I/O commands as direct-attached storage (DAS) and SAN storage. In this embodiment, the I/O device 29, 39, 49 is typically an iSCSI initiator which may take a number of forms such as a software device driver that resides on or a hardware device (such as a host bus adapter (HBA) or network interface card (NIC)) connected to the client 20, 30, 40 that functions to encapsulate SCSI commands (such as boot requests) and route them over the IP network 50 to the “target” device (such as storage controller 60 or the target software on the controller 60).

The network boot system 10 further includes the external storage controller 60 that functions to manage communication with network devices and access to the pooled storage 70 and to deploy the OS and applications on the clients 20, 30, 40. To control communications, the controller 60 includes the I/O server 64 which acts to receive and respond to boot requests from the clients 20, 30, 40 and generally functions as a boot server. In iSCSI embodiments, the I/O server 64 is the target software and hardware for the I/O initiators 29, 39, 49. The target software receives the encapsulated SCSI commands over the IP network 50 and provides configuration and storage-management support. The target hardware may be integrated into the storage controller 60 or may be a gateway or bridge product to the pooled storage 70 that has no or little internal storage (but in some embodiments, the I/O server 64 has the pooled storage 70 embedded within it and no separate pooled storage device is provided).

A snapshot manager 68 is provided to control collection and storage of disk images of the network clients 20, 30, 40. A “snapshot” or clone/copy is a point-in-time preservation or copy image of a base image (such as a file, a disk, a root node, or the like) that can be used for backup or generating new images. In one embodiment, the snapshot or clone/copy is a point-in-time preservation of the base boot image 72 that is desired to be common or shared among each client 20, 30, 40. For example, a snapshot is taken of the OS and application files that are to be common or deployed to each client 20, 30, 40 and stored as the base boot image 72 in pooled storage 70. The base OS/application image 72 is stored remotely from the clients 20, 30, 40 to more efficiently use storage in the system 10. Additionally, the base boot image 72 is used as a building block for reverse snapshotting client-specific image copies 74, 76, 78 for network booting which improves storage controller 60 caching and disk seeks as all image copies used by the clients 20, 30, 40 share common blocks for OS and application files (e.g., providing spatial and temporal locality).

The system 10 is not limited to use in handling only one original base boot image 72 or base volume image, and in some embodiments, the system 10 maintains numerous base images that have differing OS and application configurations. Multiple base boot images are useful for supporting different groups of client computer systems. FIG. 1 shows one group of clients for ease of description but typical systems 10 would include and support many clients and may include more than one external storage controller 60 controlling one or more pooled storage devices 70 with each pooled storage storing one or more base boot image 72 with client or client group images.

The snapshot manager 68 further functions to control copy-on-writes to the client-specific image copies 74, 76, 78 from the clients 20, 30, 40. In prior snapshot systems, a snapshot was formed by creating a copy image of a system OS and application files or data blocks and volumes (and in some case, other data for backup) and then copy-on-writes or subsequent writes to this snapshot or copied block were logged and new blocks allocated as part of a new image.

In the present invention, the snapshot manager 68 acts to apply writes received from clients 20, 30, 40 independently to the appropriate or affected client-specific image copy 74, 76, 78, respectively, to create client-specific blocks while not affecting unchanged but shared common OS and application blocks. To facilitate full understanding of the invention, it may be useful to more fully describe snapshots, reverse snapshots, and lazy clone techniques which are used as part of the reverse snapshotting method. When a volume is snapshotted for backup purposes, the volume or base image is still in active use. When a block in volume is written, the old block is preserved by allocating memory space for the old block somewhere else and copying the old block to that allocated space and the new blocks are written to the current version or image of the volume.

In the reverse snapshot method of the invention, the base image is never written by the clients. Instead, the client-specific blocks are “allocated-on-write” with reads from the unmodified blocks coming from the base image blocks and writes going to the client-specific blocks only. An advantage of reverse snapshots are that each client does not need to physically occupy as much space as required for the base image.

In some cases, a reverse snapshot may not be the most effective technique for providing the benefits of the invention. For example, in some cases, a physical device may run out of blocks or space if every client writes to many of the blocks in the volume and the number of clients is large. In this situation, it may be more prudent to utilize “lazy clones” rather than reverse snapshots in the client image copies 74, 76, 78. In the lazy clone embodiment of the invention, the base image is not copied in its entirety. Instead, the client-specific writes to disk activate the blocks in their respective clones but there is no proactive duplication of data and client-specific blocks are not used until they are needed.

Coherency is maintained among the clients 20, 30, 40 during operation of the system 10 by this unique sharing of the unmodified blocks (via the reverse snapshot or lazy clone methods) of the base boot image 72 of the original volume. The pooled storage 70 connected to the storage controller 60 may be any standard disk, tape or other storage device for storing the base boot image 72 and client-specific image copies 74, 76, and 78 for each of the clients 20, 30, 40.

FIG. 2 illustrates generally the sequential message flow that occurs between one of the client systems 20 and the external controller 60 during a network boot operation. As shown, the I/O initiator broadcasts or issues (typically at power on or startup) a network boot request 90 over the IP network (such as Gigabit Ethernet, Ethernet, and the like) or storage communication network (such as Fibre Channel) 50 to the I/O server of the external storage controller 60. This request may take a number of forms selected to suit the communication protocol of the network 50. For example, the boot request 90 may be a bootp (or DHCP) request packet sent over the network 50 to elicit a response from the I/O server 64 which in this example would include a bootp (or DHCP) server. The I/O or boot server 64 responds by transmitting a boot reply 92 that includes an IP or other networking identifier or address assigned to or otherwise provided for the client system 20. At this point, the I/O or boot server 64 discovers the boot target for the client 20 (e.g., a SCSI target). The boot reply 92 then includes additional information including an IP address for the storage controller 60 and a path to the client 1-specific image copy 74 for use in remote booting.

Next, the client I/O initiator 29 acts to communicate with the I/O server 64 of the controller 60 to login to the I/O server 64 to gain access to the pooled storage 70. More specifically, the I/O initiator 29 obtains access to the client 1-specific image copy 74 in the pooled storage 70. The client 1 image copy 74 includes common OS and application blocks 80 and client 1-specific blocks 82 which may have been created by writes performed during ongoing operation of the network boot system 10. Note, that the common OS and application blocks 80 are shown as separate from base boot image 72 for ease of discussion but should be understood to not be physically separate entities. The client 20 then acts to boot remotely off the image copy 74 as shown by arrow 96 without downloading the image 74 to local storage on client 20, which enables the system 10 to apply the reverse snapshot technique of the present invention across multiple clients from a base image.

FIG. 3 illustrates an exemplary network boot 100 performed by the network boot system 10. Initially, at 102, a snapshot is created of the OS and application files to be deployed throughout the system 10 to the clients 20, 30, 40. The snapshot is stored as base boot image 72 and may be a copy obtained by snapshot manager 68 over network 50 of an OS and application files or backup blocks initially installed on one client 20, 30, 40 or a copy from another storage device (not shown) or alternatively, be installed onto the pooled storage 70 by any other useful methods.

Significantly, at 104, the snapshot manager 68 reverse snapshots the base image 72 for each client 20, 30, 40 in the system 10 (with the clients being identified in a network registry file (not shown) or by a polling or pinging step performed by the snapshot manager 68 over network 50). Referring to FIG. 2 for client 20, the common OS and application blocks 80 would contain the reverse snapshot of the base image 72 while the client specific blocks 82 would initially be empty or unallocated. At this point in time, each of the clients 20, 30, 40 are configured to operate similarly with no differences in the image copies 74, 76, 78 shown in FIG. 1.

At 106, writes or changes to the client disk may be received from the clients 20, 30, 40. In some embodiments, these writes or changes come from another administrative agent that sets up the unique properties of each client 20, 30, 40 to the volume. Such an administrative agent would not be simultaneously accessing the client's volume but would instead access the volume when the client was powered down. When writes are received, the writes are treated as copy-on-writes, and the process 100 continues with updating the client image copy 74, 76, 78 corresponding or allocated to the client 20, 30, 40, respectively. More specifically, new blocks are allocated and created in the “new” image copy 74, 76, 78 and are shown as client-specific blocks 82 in FIG. 2. This may be achieved by logging new writes to the image copies 74, 76, 78 and allocating new blocks (sectors) in the new image copies 74, 76, 78 or alternatively, by storing the common OS and application blocks 80 to a separate location from the newer and updateable client-specific blocks 82. As will be appreciated, this technique of applying (e.g., processing like copy-on-write commands) received writes or updates independently to each reprint or copy image 74, 76, 78 causes the copy images 74, 76, 78 to be unique but also share a common, base portion (which is significantly beneficial to the clients 20, 30, 40 for spatial and temporal locality of the unmodified blocks).

At 110, new clients may be added to the network. This is a simplified process within the system 10 as the base boot image 72 is reverse snapshotted at 104 for the new client and stored as a client image copy in pooled storage 70. The new client can then be deployed by booting remotely from the reverse snapshot and will perform a similar function as the previously deployed clients 20, 30, 40.

At 112, a network boot request (such as a bootp or DHCP request) is received by the I/O server 64. In operation, any standardized method of boot requests, such as but not limited to bootstrapping using the iSCSI protocol, may be utilized to practice the invention. The I/O server 64 processes the boot request and at 114 returns the client's assigned or determined IP or other device address. The I/O server 64 further functions at 116 to perform target discovery which typically identifies the pooled storage device 70 (or other one if multiple devices employed), the client image copy or volume (or set of data blocks) 74, 76, 78, and path to such boot image. At 118, the I/O server 64 logs the client 20, 30, or 40 into the target software and hardware device 70 storing the boot image 74, 76, 78. The client 20, 30, 40 then at 120 boots directly and remotely off the private and unique client image copy 74, 76, 78 rather than off the base boot image 72 (or rather than downloading the base boot image 72 to local bootable storage before booting). It should be understood that steps 118 and 120 typically occur concurrently with steps 106-116 as allocate-on-writes 106 are ongoing while a client is logged in to a target.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed. The network boot method and system of the present invention can readily be adapted for used in server environments, such as web server farms, as well as for desktop environments, such as schools, Internet cafes, and the like.

The network boot system and method can be modified with numerous other networks (WAN, LAN, SAN, and the like) and device arrangements that use a snapshot as a baseline state from which many new, initially identical, independent logical volumes are created in a central network storage or sent across a SAN for use by multiple independent computers. These computers perform substantially equivalent functions and thus are deployed from the logical volumes on the network storage to use the same operating system and application configurations. Many functions of the invention are preferably implemented in the software layers of an external storage controller but these functions, such as I/O server and snapshot management functions, may be performed by software running on different devices. The present invention is not limited to IP-networks and IP-devices but is instead useful for nearly all digital data transfer networks including those that utilize Fibre Channel, Infiniband, and data transport plumbing and protocols that have not yet been developed or standardized.

We claim:

1. A method of controlling a network boot for a plurality of client devices linked to a data communications network, comprising:
receiving a boot request from one of the client devices over the network;
responsive to the received boot request, determining a target boot volume from a plurality of client image copies, each of the client image copies including a boot image particular to one of the client devices linked to the network; and
providing communicative access to the requesting one of the client devices to the target boot volume, whereby the client is operable to remotely boot over the network from the target boot volume.

2. The method of claim 1, further including creating a snapshot of a base boot image and creating the client image copies by copying the snapshot for each of the client devices linked to the network.

3. The method of claim 2, wherein the base boot image includes an image of operating system and application files to be shared among the client devices.

4. The method of claim 2, wherein each of the client image copies is allocated to a particular one of the client devices and includes common operating system (OS) and application blocks comprising a reverse snapshot of the base boot image and client-specific blocks unique to the particular one of the client devices.

5. The method of claim 4, further including receiving an update from a client device over the network and modifying the client-specific blocks based on the received update in the client image copy allocated to the updating client device.

6. The method of claim 5, wherein the received update comprises a write that is processed as an allocate-on-write.

7. The method of claim 2, further including storing the snapshot and adding a new one of the client devices to the network including repeating, with the previously stored snapshot, the creating of the client image copies for the new client device.

8. The method of claim 1, wherein the network is an Internet protocol (IP) based network.

9. An external storage controller for managing network booting within a storage communication network, comprising:
a snapshot manager adapted for creating a snapshot of a base boot image, for storing the base boot image in a linked storage device, for creating a reverse snapshot based on the snapshot for client devices in the network to the storage device, and for allocating one of the reverse snapshots to each of the client devices as client-specific image copies; and
an input and output server linked to the network receiving a boot request from a client device broadcast on the network and responding to the boot request by providing access to a client-specific image copy in the storage device allocated to the requesting client device.

10. The controller of claim 9, further including means for determining based on the boot request the client-specific image copy to provide the requesting client device access.

11. The controller of claim 9, wherein the base boot image includes an operating system and application files image and wherein each of the client'specific reverse snapshots includes the operating system and application files image and a client-specific information portion.

12. The controller of claim 11, wherein the client-specific information portion is alterable during operation of the controller.

13. The controller of claim 12, wherein the snapshot manager is adapted to apply writes received from a particular client device by the input and output server as writes to the client-specific information portion of a client-specific image copy allocated to the particular client device.

14. A computer system for deploying multiple client devices communicatively linked to a network, comprising:
a plurality of client components that send boot requests over the network;
a snapshot component that creates a base boot image comprising an operating system and application files image and client image copies from the base boot image for each of the client components;
a pooled storage component that stores the client image copies; and
a communication component that receives the boot requests from the client components and provides the client components with remote access to the client image copies on the pooled storage component.

15. The system of claim 14, wherein the network is an Internet protocol (IP) based network and the client components include initiators to encapsulate the boot requests in TCP/IP.

16. The system of claim 14, wherein the client components perform equivalent functions based on the operating system and application files image.

17. The system of claim 14, wherein the communication component further determines an allocated one of the client image copies for each of the client components that broadcast the boot requests and provides remote access to the client components only to the allocated ones determined associated to each of the client components.

18. The system of claim 14, wherein the client components further transmit information update messages on the network and the snapshot component further independently modifies the client image copies corresponding to the transmitting ones of the client components, whereby each modified one of the client image copies differs from other ones of the client image copies.

19. The system of claim 18, wherein the client image copies include a storage area for storing information from the base boot image and a storage area for storing information from the information update messages.
